(19) United States
(12) Patent Application Publication
(10) Pub. No.: US 2009/0020574 A1
(43) Pub. Date: Jan. 22, 2009

(54) Mower tote

(76) Inventors: Robert F. Sloan, Bellbrook, OH (US); Jennifer Sloan Sanders, Tampa, FL (US)

Correspondence Address: JENNIFER SLOAN SANDERS, 14510 MECCA PL, TAMPA, FL, 33625, US

(21) Appl. No.: 12/217,889

(22) Filed: Jul. 10, 2008

Related U.S. Application Data
(60) Provisional application No. 60/959,548, filed on Jul. 16, 2007.

(51) Int. Cl. B60R 9/00

(52) U.S. Cl. 224/401; 224/572

(57) ABSTRACT

An accessory item for residential use lawn mower, having the nature of a storage bag and being comprised of weather and UV resistant materials, which provides a method of convenient, onboard storage of items commonly used during the operation of a residential use lawn mower, being set on a parallel plane between the two sides of the lawn mower handles, having two defined, expandable pockets which act as receptacles for items such as lawn trash bags, lawn and garden tools, lawn & garden care products, bottled beverages, and lawn and garden debris, and requiring no tools for its installation, removal, or repositioning on lawn mower.

The invention is an accessory item, universal in size, to be utilized in companion with a residential use lawn mower as a convenient method of transporting items commonly used during the normal operation of a residential use lawn mower such as lawn trash bags, lawn and garden tools, lawn & garden care products, bottled beverage, as well as a convenient, onboard receptacle for lawn and garden debris. The invention is weather and UV resistant and requires no tools for its installation.

The embodiment of the invention is comprised of two wall sheets of a woven material stitched together to define a pouch portion having two sections (FIG. 1). The top wall sheet (FIG. 1, B) shall be of a greater length than the base wall sheet (FIG. 1, A) and shall be stitched to the base wall sheet (FIG. 1, b2) so as to form two pouched sections (FIG. 1, b3, b4), having a single inverted pleat (FIG. 1, b5) per each section so as to allow expansion of each section to accommodate the insertion of bottled beverage, lawn care products, lawn trash bags and lawn debris. The upper edge of the top wall sheet shall be folded inward and stitched to form a hem (FIG. 1, b1) leaving a reveal of the base wall sheet at the upper edge (FIG. 1, A). The overall perimeter of the pouch shall have a stitched on edge binding (FIG. 1, C) to provide strength and coverage of raw edges of woven material. Grommets (FIG. 1, D, D1) shall be set equally in each of the four corners of the embodiment, the lower two grommets (FIG. 1, D1) being set through both the base (FIG. 1, A) and the top wall (FIG. 1, B) sheets. Grommets (FIG. 1, D, D1) shall be utilized to facilitate the fastening of the embodiment to the handle portions of a residential use lawn mower by the threading through of releasable cable ties, (FIG. 1, E), one per each grommet, and the fastening of each cable tie (FIG. 2, A) around the handle portions of the lawn mower (FIG. 2, B) with sufficient tension so as to set the embodiment (FIG. 2, C) on a parallel plane to the handle portions (FIG. 2).

All materials utilized in the construction of the invention are of a durable, UV resistant, weather resistant nature as follows: High density polyethylene mesh fabric, Acrylic edge binding—Double, 1″, UV stabilized polypropylene grommets—1⅛″ outside diameter, ½″ inside hole diameter when set, Polyester colorfast thread—Size T135, Monofilament thread, bobbin—Size 18, Nylon, UV resistant, releasable cable ties—8″.

### DRAWINGS

FIG. 1 is a front perspective view in accordance of the total of the invention.

FIG. 2 is a condensed front perspective view of the invention as fastened to lawn mower handle portion.

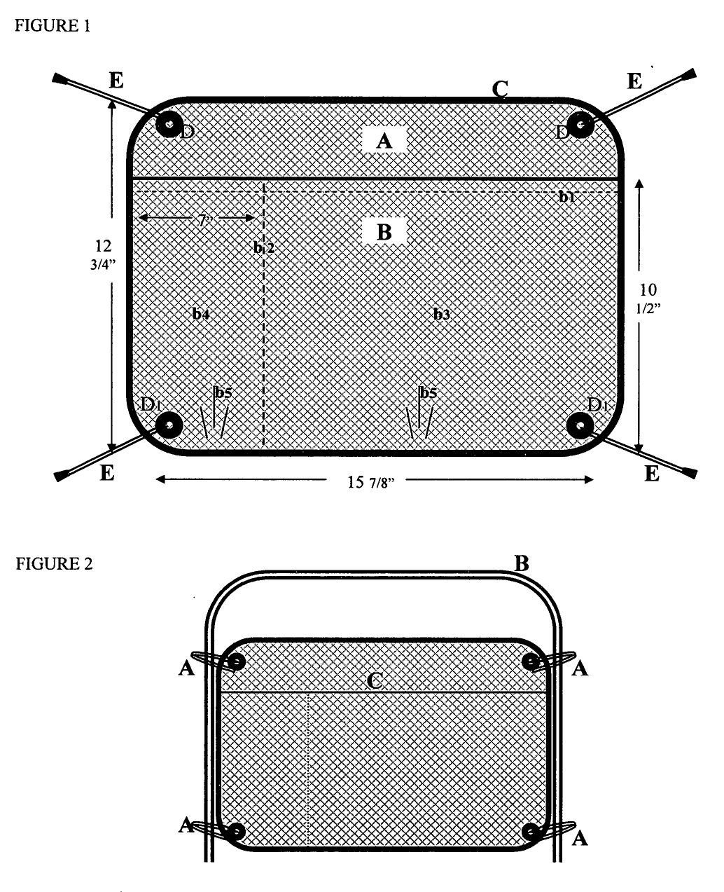

The embodiments of the invention in which an exclusive property or privilege is claimed are defined as follows:

1. A lawn mower accessory item, universal in size, to be utilized in companion with a residential use lawn mower to provide on-board transport of commonly used lawn & garden tools, products, bottled beverage and lawn debris receptacle comprising: two wall sheets of a weather and UV resistant woven material stitched together to define a pouch portion having defined sections and a single inverted pleat per each section so as to allow for expansion, a stitched on edge binding to provide strength and coverage of raw edges of woven material, grommets set equally in each of the four corners of the embodiment to facilitate the fastening of the embodiment to the handle portions of a residential use lawn mower by the threading through of releasable cable ties, one per each grommet, and the fastening of each cable tie around the handle portions of the lawn mower, not requiring the use of any tools, with sufficient tension so as to set the embodiment on a parallel plane to the handle portions.
